(19) United States
(12) Patent Application Publication
(10) Pub. No.: US 2017/0150489 A1
(43) Pub. Date: May 25, 2017

(54) USER CENTRIC CACHE ALLOCATION METHOD IN INFRASTRUCTURE WIRELESS MESH NETWORK AND APPARATUS THEREFOR

(71) Applicant: Korea Advanced Institute of Science and Technology, Daejeon (KR)

(72) Inventors: JunKyun CHOI, Daejeon (KR); Seung Hyun JEON, Deajeon (KR); Sanghong AHN, Deajeon (KR)

(21) Appl. No.: 15/288,177

(22) Filed: Oct. 7, 2016

(30) Foreign Application Priority Data
Nov. 24, 2015 (KR) 10-2015-0164927

(51) Int. Cl. H04W 72/04; H04L 29/08; H04W 40/02

(52) U.S. Cl. CPC H04W 72/048; H04W 40/02; H04L 67/2842; H04W 84/18

(57) ABSTRACT

A user centric cache allocation (UCA) method and apparatus in an infrastructure wireless mesh network (WMN) are disclosed. The method includes determining an allocation of a cache in a mesh router (MR) for content stored in the MR in an environment where mobile terminals and MRs establish the infrastructure WMN and allocating the cache to the content based on the determination allocation.

### CROSS-REFERENCE TO RELATED APPLICATIONS

A claim for priority under 35 U.S.C. §119 is made to Korean Patent Application No. 10-2015-0164927 filed Nov. 24, 2015, in the Korean Intellectual Property Office, the entire contents of which are hereby incorporated by reference.

### BACKGROUND

Embodiments of the inventive concepts described herein relate to a user centric cache allocation (UCA) method for determining how many of caches are allocated to content in an infrastructure wireless mesh network (WMN) environment.

An infrastructure WMN is configured with mesh routers (MRs) as wireless-fidelity (Wi-Fi) access points (APs). Such MRs may be connected in a space such as a campus or office by a multi-hop. Expected transmission time (ETT) routing is mainly used in the WMN. When the ETT routing is performed, a network established by the multi-hop results in deterioration in throughput. Particularly, if a mobile terminal or a mobile user downloads popular content from a video on demand (VoD) server or shares peer-to-peer (P2P) content, a download delay may occur due to a collision between mobile terminals. Thus, there is a need for technologies of solving the download delay which occurs in the WMN.

Korean Patent No. 10-1404008 relates to an integrated P2P and cache apparatus about content services in WMNs and discloses technologies of finding a minimum path using an EET routing scheme.

### SUMMARY

Embodiments of the inventive concepts provide a user centric cache allocation (UCA) technology of determining how many of local caches in a mesh router (MR) to content in an infrastructure WMN environment.

Embodiments of the inventive concepts provide a generic algorithm-UCA (GA-UCA) technology of performing switching to move content between a cache in an MR and a storage such as a hard disc using a GA.

According to an aspect of an embodiment, a UCA method in an infrastructure WMN may include determining an allocation of a cache in a mesh router (MR) for content stored in the MR in an environment where mobile terminals and MRs establish the infrastructure WMN and allocating the cache to the content based on the determination allocation.

The determining of the allocation of the cache may include determining the allocation of the cache based on a cache cost generated as the MR operates a local cache, a download delay of content requested from the mobile terminal, and user satisfaction.

The mobile terminal which requests the content may access the closest MR from the mobile terminal among the MRs to receive the content.

The method may further include searching for the requested content based on expected transmission time (ETT) routing, if there is no the requested content in the accessed MR.

The MRs may share content information stored in a cache of each of the MRs.

The determining of the allocation of the cache may include correcting an ETT value for searching for the content requested from the mobile terminal using a genetic algorithm (GA).

The content stored in a storage of an MR may be stored in a cache of the MR by moving to the cache of the MR, if the MR which stores the content requested from the mobile terminal correspond to two hops or more from the mobile terminal.

The content requested from the mobile terminal may be stored in a storage of an MR adjacent to the mobile terminal by moving from a cache of an MR which stores the content to the storage of the MR adjacent to the mobile terminal.

The determining of the allocation of the cache may include determining the allocation of the cache for the content by repeatedly performing uniform crossover and mutation for the content requested from the mobile terminal, stored in at least one of the MRs.

According to another aspect of an embodiment, a UCA apparatus in an infrastructure WMN may include a determination unit configured to determine an allocation of a cache in a mesh router (MR) for content stored in the MR in an environment where mobile terminals and MRs establish the infrastructure WMN and an allocation unit configured to allocate the cache to the content based on the determination allocation.

The determination unit may determine the allocation of the cache based on a cache cost generated as the MR operates a local cache, a download delay of content requested from the mobile terminal, and user satisfaction.

The mobile terminal which requests the content may access the closest MR from the mobile terminal among the MRs to receive the content.

The apparatus may further include a search unit configured to search for the requested content based on expected transmission time (ETT) routing, if there is no the requested content in the accessed MR.

The MRs may share content information stored in a cache of each of the MRs.

The determination unit may determine the allocation of the cache for the content in consideration of a cache hit ratio.

The determination unit may correct an ETT value for searching for the content requested from the mobile terminal using a genetic algorithm (GA).

The content stored in a storage of an MR may be stored in a cache of the MR by moving to the cache of the MR, if the MR which stores the content requested from the mobile terminal correspond to two hops or more from the mobile terminal.

The content requested from the mobile terminal may be stored in a storage of an MR adjacent to the mobile terminal by moving from a cache of an MR which stores the content to the storage of the MR adjacent to the mobile terminal.

The determination unit may determine the allocation of the cache for the content by repeatedly performing uniform crossover and mutation for the content requested from the mobile terminal, stored in at least one of the MRs.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing illustrating a configuration of an infrastructure wireless mesh network (WMN) according to an embodiment;

FIG. 2 is a block diagram illustrating a configuration of a cache allocation device in an infrastructure WMN environment in an embodiment;

FIG. 3 is a flowchart illustrating a UCA method in an embodiment;

FIG. 4 is a drawing illustrating a process of performing expected transmission time (ETT) routing to find content requested from a mobile terminal in an embodiment;

FIG. 5 is a drawing illustrating an operation of allocating a cache to content using a genetic algorithm (GA) in an embodiment;

FIG. 6 is a drawing illustrating cache allocation if a link rate is high and if a cache cost is low in an embodiment;

FIG. 7 is a drawing illustrating cache allocation if a link rate is high and if a cache cost is high in an embodiment;

FIG. 8 is a drawing illustrating cache allocation if a link rate is low and if a cache cost is low in an embodiment;

FIG. 9 is a drawing illustrating cache allocation if a link rate is low and if a cache cost is high in an embodiment;

FIG. 10 is a drawing illustrating a utility based on a cache cost if a link rate is high in an embodiment; and

FIG. 11 is a drawing illustrating a utility based on a cache cost if a link rate is low in an embodiment.

### DETAILED DESCRIPTION

Hereinafter, an embodiment will be described in detail with reference to the accompanying drawings.

An embodiment relates to technologies of allocating a local cache in each of mesh routers (MRs) which exist in an infrastructure wireless mesh network (WMN) environment to provide content. Particularly, an embodiment relates to technologies of determining how many of caches are allocated to content in consideration of satisfaction of a user who has a mobile terminal based on a popularity-based content request volume, a cache cost which is an operation cost which should be paid as a WMN provider operates a cache of an MR, and a download delay which occurs when searching for content of a mobile terminal using expected transmission time (ETT) routing.

Further, an embodiment relates to technologies of reducing a download delay by correcting an ETT value using a genetic algorithm (GA). If there is no content a mobile terminal wants in a first MR accessed by the mobile terminal, ETT routing should be performed to search for content. The ETT routing may have an influence on a download delay of the mobile terminal. Thus, an embodiment of the inventive concept relates to technologies of performing user centric cache allocation (UCA) in consideration of user traffic as mobile terminals which access an MR increase in number and content popularity. Particularly, an embodiment relates to technologies of determining an optimal cache allocation to be allocated to content stored in each of MRs using user characteristics such as content popularity and the increased number of mobile terminals.

In the specification, various equations are used to determine how many of local caches in an MR to content, and notations used for equations are shown in Table 1 below.

TABLE 1

| Notations | Explanation |
|---|---|
| Aₖ | Chromosome vector on the existence for k^{th} content in WMNs |
| αₖᵢ | Gene on the existence of kth content within i^{th} MR |
| | (i.e., If the content exists, αₖᵢ = 1; otherwise, αₖᵢ = 0.) |
| H^{k} (αₖ) | k^{th} content's cache hit ratio, dependent on values of αₖᵢ |
| p^{k}ⱼ | k^{th} content's popularities requested from j^{th} mobile user based |
| | on Zipf-like distribution |
| s^{k} | k^{th} content's cache size at each MR |
| C_{ca} | Cost for storing content in cache for each MR paid by a WMN |
| | provider |
| ETT^{k} (Aₖ) | ETT consumed to search the k^{th} content at the cache of an MR |
| | affected by Aₖ |
| K | The number of the total content in WMNs |
| N_{MR} | The number of MRs in WMNs |
| N_{U} | The number of mobile users in WMNs, which consists of N¹_{U} |
| | for 1-hop and N²_{U} for 2-hop |
| η | Scalable factor |

In the specification, the term “user centric” may indicate that a user profile is recognized. Satisfaction of a user used to calculate a cache allocation may indicate characteristics of content for a cache hit ratio, content popularity, and the number of mobile terminals. Herein, the cache hit ratio may indicate the ratio of the total number of times of accessing a cache of an MR to download content stored in the cache to the existence of desired content (i.e., content requested from a mobile terminal) in the cache.

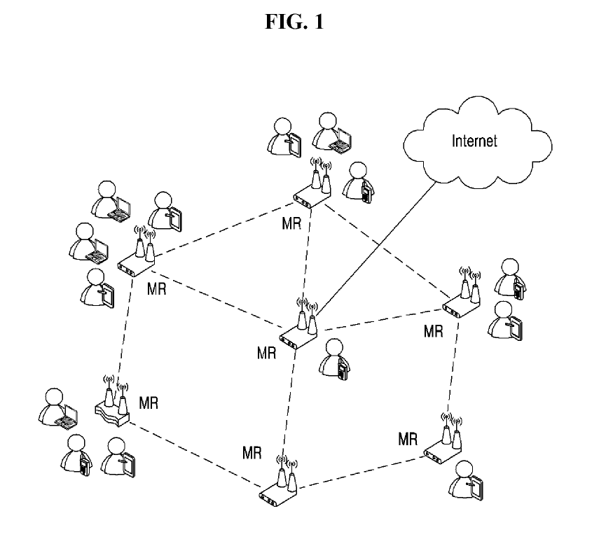

FIG. 1 is a drawing illustrating a configuration of an infrastructure wireless mesh network (WMN) according to an embodiment.

In FIG. 1, it is assumed that a plurality of mobile terminals and a plurality of MRs have a uniform mesh structure in the infrastructure WMN and that the WMN is established in places such as a campus and an office. It is assumed that all MRs are connected over a wireless multi-hop network to reduce an installation cost due to wired links.

Each of the mobile terminals such as a smartphone, a notebook, and a tablet personal computer (PC) may access MRs and may request content a user who has the mobile terminal wants. For example, each of the mobile terminals may access an MR located in the closest distance from the corresponding mobile terminal to request desired content. Herein, the content may include a moving image such as a movie or a music video, a still image such as a photo, a document of a text format, and the like. In this case, the mobile terminal may access an MR based on content popularity. The content popularity may be obtained based on a Zipf-like distribution.

In FIG. 1, MRs may connect by multi-hop to perform multi-hop routing, and one of the MRs may connect to a core network. For example, the MR may be a fixed 802.11n access point (AP) and may be arranged outside, and one of the MRs may connect to a cellular network such as a long term evolution (LTE) network. In this case, the MRs may connect to each other by an ad hoc type and may connect to a wired network other than the cellular network.

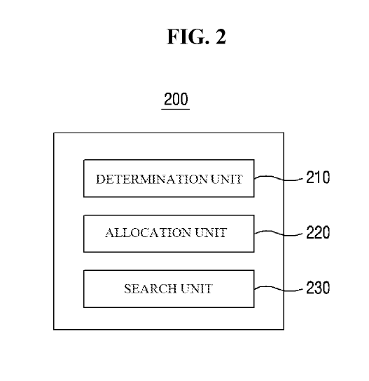

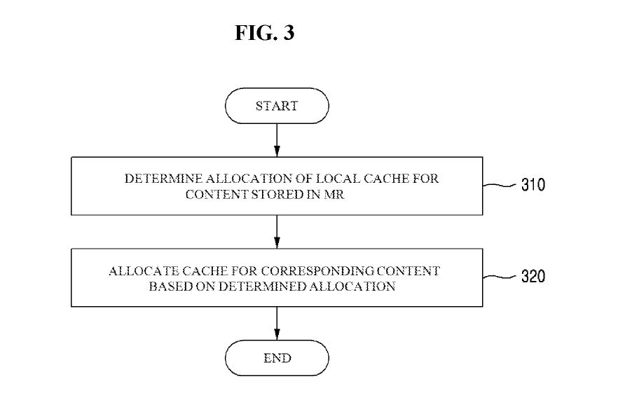

FIG. 2 is a block diagram illustrating a configuration of a cache allocation device in an infrastructure WMN environment in an embodiment. For example, the cache allocation device may exist in an MR and may be included in a separate server which managers MRs. FIG. 3 is a flowchart illustrating a user centric cache allocation (UCA) method in an embodiment. In FIG. 3, steps 310 and 320 may be performed by a determination unit 210, an allocation unit 220, and a search unit 230 of FIG. 2.

According to FIG. 2, a cache allocation device 200 may include the determination unit 210, the allocation unit 220, and the search unit 230.

In step 310, the determination unit 210 may determine an allocation of a local cache in an MR for content stored in the MR in an infrastructure WMN environment. In this case, the determination unit 210 may determine the allocation of the cache for the content based on a cache cost, a download delay of the content, and user satisfaction with content requested from a mobile terminal. For example, the determination unit 210 may calculate a utility for determining an allocation of a cache based on Equation 1 below.

$$U = {max}_{{s}^{k}} {\sum }_{j = 1}^{{N}_{U}} {\sum }_{k = 1}^{K} log \{ 1 + η {H}^{k} ( {A}_{k} ) {p}_{j}^{k} {s}^{k} \} - {\sum }_{k = 1}^{K} {\sum }_{i = 1}^{{N}_{MR}} {s}^{k} {α}_{ki} {c}_{ca} - {\sum }_{j = 1}^{{N}_{U}} {\sum }_{k = 1}^{K} {ETT}^{k} ( {A}_{k} ) s . t . {s}^{k} \geq 0 , {A}_{k} = ( {α}_{ki} ∈ \{ 0 , 1 \} ) , \qquad [ Equation 1 ]$$

In Equation 1, η may represent a scalable factor. Aₖ may represent a chromosome vector which exists in k^{th} content in each of MRs. p^{k}ⱼ may represent popularity of the k^{th} content requested from a j^{th} mobile terminal. s^{k} may represent a cache allocated for the k^{th} content at each of the MRs. c_{ca} may represent a cache cost which is an operation cost paid to store content in a cache for each MR by a WMN provider. Herein, a cache hit ratio for the k^{th} content may be represented as H^{k}(Aₖ) using Aₖ. An ETT for the k^{th} content may be represented as ETT^{k}(Aₖ). αₖᵢ may refer to a gene which exists in the k^{th} content stored in an i^{th} MR.

Equation 1 above may be classified into a first portion to a third portion. The first portion may a portion indicating satisfaction of all mobile terminals for the cache s^{k} allocated for the k^{th} content and may be based on popularity of content. Herein, the satisfaction may be satisfaction of a user who has a mobile terminal with popularity-based content and may refer to satisfaction of the user with x when popularity of specific content is x. The second portion may indicate a cache cost per MR paid by the WMN provider. In this case, cache allocation for the k^{th} content may be shared by all mobile terminals. For example, information about content for which a cache of an MR is allocated may be periodically shared at intervals of a time between MRs. Information about how many of caches are allocated for the k^{th} content may be shared between mobile terminals and MRs. In an embodiment, it is assumed that the WMN provider pays a cache cost to provide high satisfaction to the user who has the mobile terminal since he or she considers using a cache based on an operation cost. The third portion may indicate an ETT of each of all mobile terminals based on Aₖ, that is, may refer to a content search delay of the mobile terminal using an ETT metric.

In other words, according to Equation 1, the determination unit 210 may calculate an optimal cache allocation of maximizing a utility which is a value obtained by subtracting all cache costs of each of MRs operated by the WMN provider and a content download delay of each of mobile terminals from the sum of satisfaction of users who have the mobile terminals. Herein, since the satisfaction is based on popularity of content, there may be a high probability that the satisfaction of the user will be higher when the popularity of the content is higher. There may be a high probability that the satisfaction of the user will be lower when the popularity of the content is lower. Thus, to determine a cache allocation for optimizing the satisfaction of the user, the determination unit 210 may determine the cache allocation to allocate more caches for content with high popularity than content with low popularity and allocate fewer caches for content with low popularity than content with high popularity.

In step 320, the allocation unit 220 may allocate a cache for the corresponding content based on the determined cache allocation. In other words, the corresponding content stored in a hard disc of an MR may be stored in the cache by being moved and copied to the cache based on the determined cache allocation. If content requested from a mobile terminal is stored in a cache of an MR accessed by the mobile terminal, the mobile terminal may reduce a download delay by downloading the content from the cache. In this case, if there is no the requested content in the cache of the MR, the search unit 230 may search MRs which exist in a WMN for the content.

Referring again to Equation 1, in the first portion of Equation 1, H^{k}(Aₖ) may be represented with Equation 2 below.

$${H}^{k} ( {A}_{k} ) = \frac{1}{{N}_{MR}} \times {\sum }_{i = 1}^{{N}_{MR}} {α}_{ki} \leq 1 , \qquad [ Equation 2 ]$$

In Equation 2, NMR may denote the number of MRs in the WMN. In Equation 2, if all of αₖᵢ are “1”, the cache hit ratio H^{k}(Aₖ) for the k^{th} content is “1”. ETT^{k}(Aₖ) included in the third portion of Equation 1 may have two paths like Equation 3 below.

$${ETT}^{k} ( {A}_{k} ) = \{ \begin{matrix}{\sum }_{i = 1}^{{N}_{U}^{1}} {α}_{ki} {ETT}^{k} as 1 - hop , \\ {\sum }_{i = 1}^{{N}_{U}^{2}} ( 1 - {α}_{ki} ) {( {ETT}^{k} )}^{2} as 2 - hop ,\end{matrix} \} \qquad [ Equation 3 ]$$

In Equation 3, N_{U}¹ may denote the number of mobile terminals having a one-hop delay requested to search for content requested from the mobile terminal. N_{U}² may denote the number of mobile terminals having a two-hop delay requested to search for the content. ETT^{k} may be

$$\frac{1}{1 - p} \times \frac{{s}^{k}}{B} .$$

In this case, if there is content in a cache of an MR first accessed by a mobile terminal to request content, the mobile terminal may belong to N_{U}¹, and the other mobile terminals may belong to N_{U}². p may denote a probability that the k^{th} content (or copied content) stored in a cache of an i^{th} MR will fail in transmission. In other words, p may refer to the probability of unsuccessful transmission. B may denote a bandwidth of a link such as a raw data rate. Herein, the determination unit 210 may calculate the probability p of transmission failure based on Equation 4 below.

p=1−(1−p_{c})(1−pₑ), [Equation 4]

In Equation 4, p_{c} may denote a collision probability. pₑ may denote an error probability. The collision probability p_{c} and the error probability pₑ may be calculated using Equations 5 and 6 below.

p_{c}=1−(1−1/W_{avg})^{N}^{_{U}}⁻¹, [Equation 5]

In Equation 5, W_{avg} may denote an average backoff window size. N_{U} may denote the number of mobile terminals in a WMN.

pₑ=1−(1−P_{b})^{L}, [Equation 6]

In Equation 6, b may refer to a bit error rate (BER). L may refer to a maximum length of an A-medium access control (MAC) service data unit aggregation (A-MSDU) frame size. Herein, since it is assumed that the WMN has the uniform mesh structure, it may be assumed that ETT values between two links which exist between some MRs in the WMN are the same as each other. Each ETT may be accessed to solve an optimization problem using two methods. First, an optimization problem for a one-hop may be represented with Equation 7 below.

$$\frac{\partial U}{\partial {s}^{k}} = {\sum }_{k = 1}^{K} \{ {\sum }_{j = 1}^{{N}_{U}^{1}} \frac{η {H}^{k} ( {A}_{k} ) {p}_{j}^{k}}{1 + η {H}^{k} ( {A}_{k} ) {p}_{j}^{k} {s}^{k}} \} - {\sum }_{k = 1}^{K} {\sum }_{i = 1}^{{N}_{MR}} \{ {α}_{ki} {c}_{ca} + {\sum }_{j = 1}^{{N}_{U}^{1}} \frac{{α}_{ki}}{( 1 - p ) B} ) , \\ \frac{{\partial }^{2} U}{{\partial }^{2} {s}^{k}} = - {\sum }_{j = 1}^{{N}_{U}^{1}} {\sum }_{k = 1}^{K} \frac{{\{ η {H}^{k} ( {A}_{k} ) {p}_{j}^{k} \}}^{2}}{{\{ 1 + η {H}^{k} ( {A}_{k} ) {p}_{j}^{k} {s}^{k} \}}^{2}} < 0. \qquad [ Equation 7 ]$$

In case of a mobile terminal having a one-hop delay to search for content, an optimal cache allocation for the k^{th} content in each MR may be calculated using Equation 8.

$${( {s}^{k} )}^{*} = {\sum }_{k = 1}^{K} {\sum }_{j = 1}^{{N}_{U}^{1}} \frac{η {H}^{k} ( {A}_{k} ) {p}_{j}^{k}}{1 + η {H}^{k} ( {A}_{k} ) {p}_{j}^{k}} \times {\{ {\sum }_{k = 1}^{K} {\sum }_{i = 1}^{{N}_{MR}} ( {α}_{ki} {c}_{ca} + {\sum }_{j = 1}^{{N}_{U}^{1}} \frac{{α}_{ki}}{( 1 - p ) B} ) \}}^{- 1} \qquad [ Equation 8 ]$$

According to Equation 8, the determination unit 210 may calculate the optimal cache allocation based on a cache hit ratio, popularity of content, a cache cost, a gene which exists in the k^{th} content, and a link bandwidth.

Finally, an optimization problem for one hop may be represented with Equations 9 and 10 below using Equation 8 above.

$$\begin{matrix}\frac{\partial U}{\partial {s}^{k}} = {\sum }_{k = 1}^{K} \{ {\sum }_{j = 1}^{{N}_{U}^{2}} \frac{η {H}^{k} ( {A}_{k} ) {p}_{j}^{k}}{1 + η {H}^{k} ( {A}_{k} ) {p}_{j}^{k} {s}^{k}} \} - {\sum }_{k = 1}^{K} {\sum }_{i = 1}^{{N}_{MR}} ( {α}_{ki} {c}_{ca} + {\sum }_{j = 1}^{{N}_{U}^{2}} \frac{2 ( 1 - {α}_{ki} ) {s}^{k}}{{( ( 1 - p ) B )}^{2}} ) , & [ Equation 9 ] \\ \frac{\partial U}{\partial {s}^{k}} = - {\sum }_{j = 1}^{{N}_{U}^{2}} {\sum }_{k = 1}^{K} \{ \frac{{\{ η {H}^{k} ( {A}_{k} ) {p}_{j}^{k} \}}^{2}}{{\{ 1 + η {H}^{k} ( {A}_{k} ) {p}_{j}^{k} {s}^{k} \}}^{2}} \} - {\sum }_{j = 1}^{{N}_{U}^{2}} {\sum }_{k = 1}^{K} {\sum }_{i = 1}^{{N}_{MR}} \frac{2 ( 1 - {α}_{ki} )}{{( ( 1 - p ) B )}^{2}} < 0 & [ Equation 10 ]\end{matrix}$$

In case of a mobile terminal having a one-hop delay to search for content, an optimal cache allocation for the k^{th} content may be represented with “a(s^{k})²+b(s^{k})+c=0”. Finally, the optimal cache allocation may be calculated based on Equation 12 below.

$${( {s}^{k} )}^{*} = \frac{- b \sqrt{{b}^{2} - 4 a c}}{2 a} > 0 , ( {s}^{k} \geq 0 ) , \qquad [ Equation 11 ]$$

In Equation 11, a, b, and c may be represented with Equation 12.

$$a = {\sum }_{k = 1}^{K} {\sum }_{i = 1}^{{N}_{MR}} {\sum }_{j = 1}^{{N}_{U}^{2}} \frac{2 ( 1 - {α}_{ki} )}{{\{ ( 1 - p ) B \}}^{2}} , \\ b = {\sum }_{k = 1}^{K} {\sum }_{i = 1}^{{N}_{MR}} {α}_{ki} {c}_{ca} , \\ c = - {\sum }_{k = 1}^{K} {\sum }_{j = 1}^{{N}_{U}^{2}} \frac{η {H}^{k} ( {A}_{k} ) {p}_{j}^{k}}{1 + η {H}^{k} ( {A}_{k} ) {p}_{j}^{k}} . \qquad [ Equation 12 ]$$

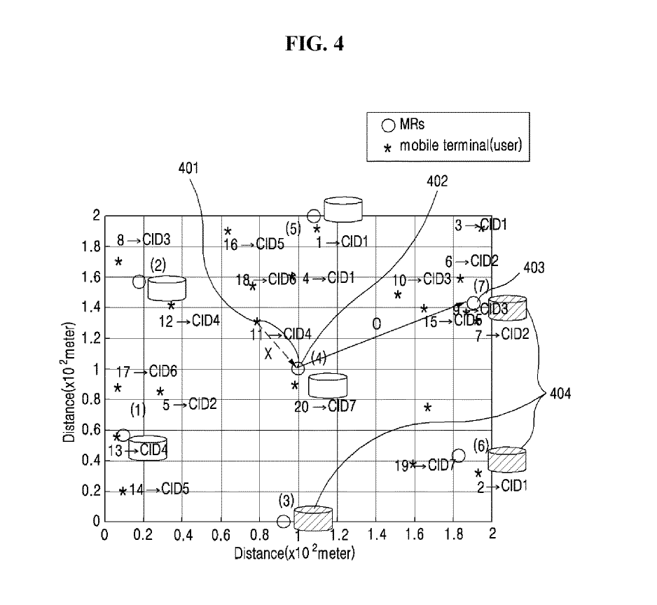

FIG. 4 is a drawing illustrating a process of performing ETT routing to find content requested from a mobile terminal in an embodiment.

FIG. 4 illustrates that a content identification 4 (CID4) is stored in three 404 of MRs which establish a WMN and that the CID4 is not stored in each of the other MRs.

In FIG. 4, it is assumed that there are 7 MRs. Mobile terminals may be randomly arranged. In FIG. 4, the expression “11→CID4” may mean that a mobile terminal11 401 requests the CID4. A mobile terminal which requests content may access an MR located within the closest distance from the mobile terminal. In this case, each of all MRs may have a local cache and a storage such as a hard disc. The content may be stored in at least one of the cache and the storage. The cache and the storage may switch to each other to move the content.

For example, if the mobile terminal11 401 wants to find the CID4, it may access an MR4 402 located within the closest distance from it to find the CID4. A cache hit ratio of the CID4 may be 3/7. In this case, since there is no the requested CID4 in the MR4 402, ETT routing may be performed to find the CID4. The mobile terminal11 401 may perform routing from the MR4 402 to an MR7 403.

As such, in case of two hops, content may switch. For example, content stored in a storage of the MR7 403 corresponding to the two hops may move to a cache of the corresponding MR7 403 to be stored in the cache of the MR7 403. The mobile terminal11 401 may download the requested CID4 from the cache, thus reducing a download delay by a multi-hop. In FIG. 4, an embodiment is exemplified as the content switches in case of the two hops. However, embodiments are not limited thereto. For example, since there is no desired content in an MR first accessed by a mobile terminal, if the mobile terminal accesses an MR which stores the desired content by performing routing by two hops or more, the content may be moved from a storage of the corresponding MR to a cache of the corresponding MR to be stored in the cache of the corresponding MR. For example, at least part or all of the content stored in the storage may be copied onto the cache to be stored in the cache. In other words, the at least part or all of the corresponding content may be copied onto the cache of the corresponding MR based on a cache allocation calculated in consideration of popularity of the corresponding content, satisfaction of the corresponding content, and a cache cost to be stored in the cache of the corresponding MR. In this case, when content has higher popularity, more caches are allocated to the content. When content has lower popularity, fewer caches are allocated to the content. Thus, amounts (rates) stored in a cache may different for each content.

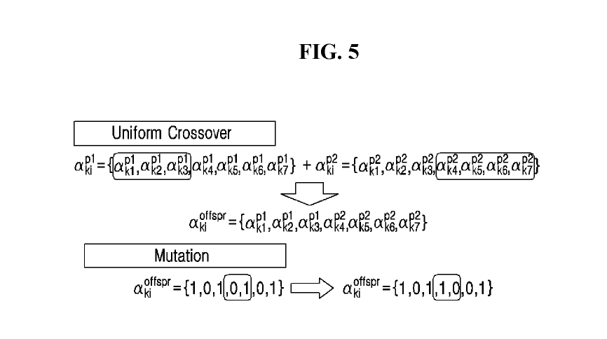

FIG. 5 is a drawing illustrating an operation of allocating a cache to content using a genetic algorithm (GA) in an embodiment.

A description will be given of a process of performing UCA using the GA with reference to FIG. 5. An EET value may be reduced by changing a location of content stored in each of other MRs using the GA. For example, if content (e.g., k^{th} content) requested from a mobile terminal exists in an MR located within a two-hop distance from the mobile terminal, the content (e.g., the k^{th} content) stored in a cache of the MR located within the two-hop distance may be moved to an MR located within a one-hop distance to be stored in the MR located within the one-hop distance. In other words, the requested content may be copied onto a cache or a storage such as a hard disc in an MR first accessed by the mobile terminal or in a peripheral MR adjacent to the mobile terminal to be stored in the cache or the storage. As such, content may be moved from a hard disc in the same MR to a cache in the same MR to be stored in the cache. The content may be copied from a cache or a hard disc of an MR which stores the requested content to a cache or a hard disc of another MR to be stored in the cache or the hard disc. Thus, an EET value may be reduced, and a download delay may be reduced. In other words, a time wasted as EET routing is performed since there is no the requested content in the MR accessed by the mobile terminal may be reduced (i.e., the time may be corrected to reduce an EET value), and a download delay may be reduced.

Referring to FIG. 5, a cache hit ratio H^{k}(Aₖ) for k^{th} content of Equation 1 in the above-mentioned UCA may be applied to the GA. Herein, the cache hit ratio H^{k}(Aₖ) may be assumed like a fitness function of the GA. As uniform crossover and mutation may be repeatedly performed, an optimal cache allocation may be determined for each content using the cache hit ratio. Table 2 below represents an algorithm of allocating a cache using the GA.

TABLE 2

| | |
|---|---|
| 1: | Define H^{k}(Aₖ) |
| 2: | Define N_{MR} as R |
| 3: | Initialize population |
| 4: | for t = 1:generation iteration do |

| | |
|---|---|
| 5: | for k = 1:K do |

| | |
|---|---|
| 6: | Select random αₖ^{p1}, αₖ^{p2} by H^{k}(Aₖ) |
| 7: | αₖ^{offspr}=mutation(crossover( αₖ^{p1}, αₖ^{p2} )) |
| 8: | if (s^{k} (αₖ^{offspr}) )* > (s^{k} (αₖ) )* then |

| | |
|---|---|
| 9: | α*ₖ = αₖ^{offspr} |

| | |
|---|---|
| 10: | end if |

| | |
|---|---|
| 11: | end for |
| 12: | Replace population α*ₖ = {αₖ₁^{offspr}, . . .α_{kR}^{offspr}} |
| 13: | if stop criteria then break |
| 14: | end if |

| | |
|---|---|
| 15: | end for |

Referring to FIG. 5 and Table 2, an initial solution population may be generated through “Initialize population”. First of all, parent sequences may be randomly generated. A child αₖᵢ^{offspr} may inherit some sequences from first and second parents αₖᵢ using uniform crossover. For example, according to FIG. 5, the child αₖᵢ^{offspr} may inherit αₖ₁^{p1}, αₖ₂^{p1}, and αₖ₃^{p1} from the first parent and may inherit αₖ₄^{p2}, αₖ₅^{p2}, αₖ₆^{p2}, and αₖ₇^{p2} from the second parent. Next, mutation may be applied to the child αₖᵢ^{offspr} including the sequences inherited from the parents. If the mutation is applied, “1” may be changed to “0” and “0” may be changed to “1”. In other words, the child αₖᵢ^{offspr} is {1, 0, 1, 0, 1, 0, 1} before the mutation, but the child αₖᵢ^{offspr} may be changed to {1, 0, 1, 1, 0, 0, 1} through the mutation. For example, kth content stored in a 5^{th} MR may be changed from “1” to “0” (e.g., a child αₖ₅^{offspr} may be changed from “1” to “0”). That the k^{th} content is changed from “1” to “0” may mean that the k^{th} content is removed from a cache of the 5^{th} MR.

Referring again to Table 2, all content may be stored in a cache or storage of an MR based on a previously given cache hit ratio H^{k}(Aₖ). For example, if αₖᵢ is “1”, all the content may be stored in the cache. If αₖᵢ is “0”, all the content may be stored in the storage such as a hard disc. In Table 2, assuming that the number of MRs is “7” and an initial solution is {1, 0, 1, 0, 1, 0, 1}, the cache hit ratio H^{k}(Aₖ) may be 4/7 based on Equation 2 above. Herein, assuming that the cache hit ratio H^{k}(Aₖ) is the fitness function of the GA, if the cache hit ratio H^{k}(Aₖ) is applied to the uniform crossover and the mutation, the cache hit ratio H^{k}(Aₖ) may be replaced if a cache allocation of a child αₖ^{offspr} is larger than that of a conventional parent αₖ. In other words, if a cache allocation of the child αₖ^{offspr} is larger than that of the parent αₖ, the child αₖ^{offspr} may have an optimal value. As such, as the uniform crossover and the mutation are repeatedly performed, sequences having the optimized parent αₖ value may be collected for each content (αₖ*={αₖ₁^{offspr}, . . . α_{kR}^{offspr}}).

As described above, in FIG. 5, an embodiment is exemplified as how many of caches are allocated for content using the GA-UCA. However, embodiments are not limited thereto. For example, the GA-UCA and the UCA may be combined to determine a cache allocation. For example, if there is requested content in an MR first accessed by a mobile terminal, a determination unit 210 of FIG. 2 may determine a cache allocation using the UCA. If there is no the content in the first accessed MR, the determination unit 210 may determine a cache allocation using the GA-UCA. In addition, the UCA and the GA-UCA may be adaptively used based on a link rate and a cache cost of a WMA. For example, if the link rate is high and if the cache cost is low, the determination unit 210 may allocate a cache using the GA-UCA for allocating the most caches and maximizing satisfaction. Next, if the link rate is low, the determination unit 210 may allocate a cache using the UCA.

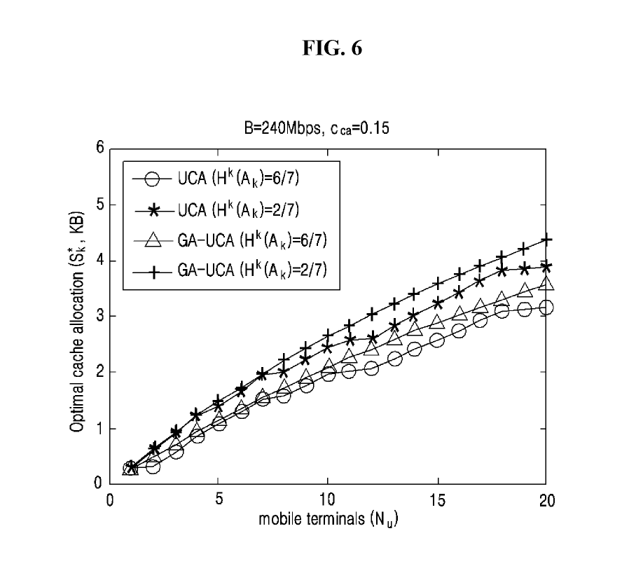

FIG. 6 is a drawing illustrating cache allocation if a link rate is high and if a cache cost is low in an embodiment.

In FIG. 6, if a link rate B is high to have 240 Mbps and if a cache cost c_{ca} is low to have 0.15, except that desired content exists in an MR first accessed by a mobile terminal, that is, that N_{U} is “1”, it may be verified that it is possible to allocate more caches in GA-UCA of allocating a cache using a GA than UCA of allocating a cache without using the GA. In other words, in case of the GA-UCA of allocating the cache using the GA, more caches may be allocated because an EET value is reduced.

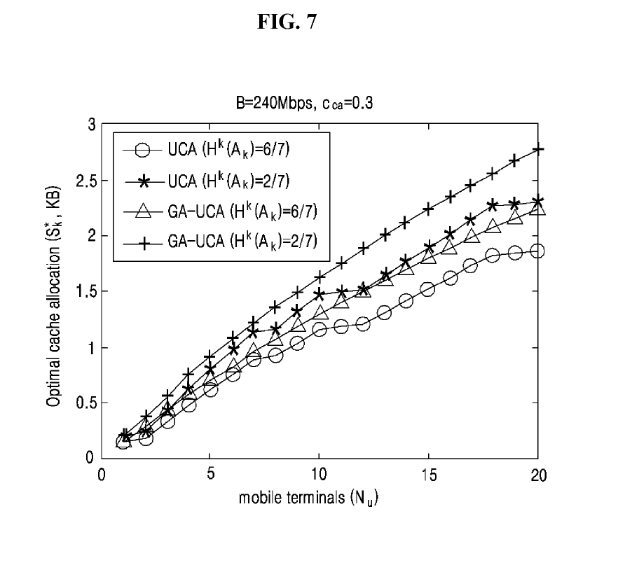

FIG. 7 is a drawing illustrating cache allocation if a link rate is high and if a cache cost is high in an embodiment.

In FIG. 7, a link rate B may be high to have 240 Mbps, and a cache cost c_{ca} may be high to have 0.3. Like FIG. 6, except that N_{U} is “1”, it may be verified that it is possible to allocate more caches in GA-UCA of allocating a cache using a GA than UCA of allocating a cache without using the GA. In this case, since the cache cost is higher that of FIG. 6, it may be verified that an optimal cache allocation has a little low value. As such, according to FIGS. 6 and 7, when a link rate is high, if a cache cost is high, it may be verified that a cache allocation difference between the UCA and the GA-UCA is increased. When the link rate is high, if the cache cost is low, it may be verified that the cache allocation between the UCA and the GA-UCA is decreased.

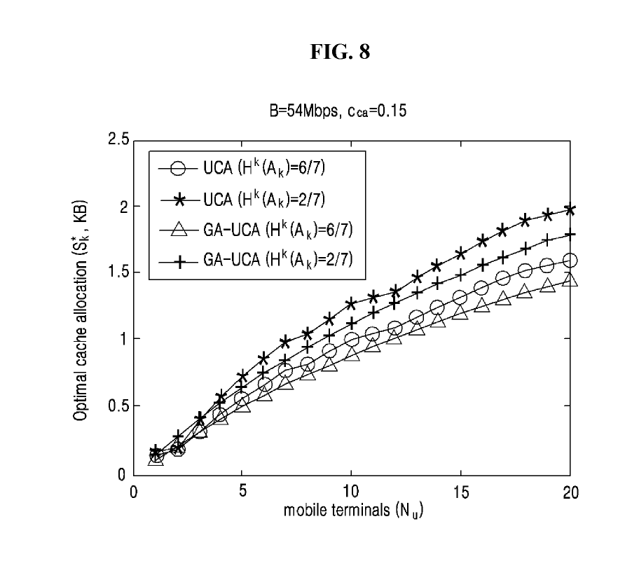

FIG. 8 is a drawing illustrating cache allocation if a link rate is low and if a cache cost is low in an embodiment.

In FIG. 8, a link rate B is low to have 54 Mbps, and a cache cost c_{ca} is low to have 0.15. According to FIG. 8, if the link rate is low, it may be verified that UCA of allocating a cache without using a GA is better cache allocation than GA-UCA of allocating a cache using the GA. Although an ETT value is corrected using the GA-UCA if the link rate is low, since a correction effect is weak, the UCA may be better cache allocation than the GA-UCA.

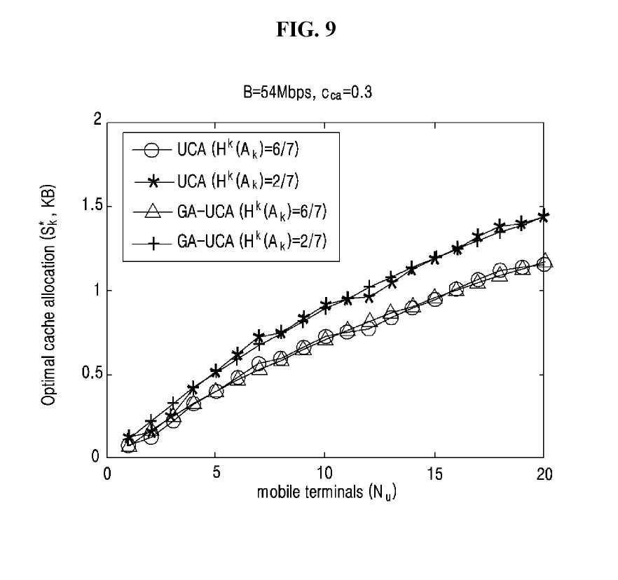

FIG. 9 is a drawing illustrating cache allocation if a link rate is low and if a cache cost is high in an embodiment.

In FIG. 9, a link rate B may be low to have 54 Mbps, and a cache cost c_{ca} may be high to have 0.3. According to FIG. 9. If the link rate is low and if the cache cost is high, it may be verified that lowest cache allocation is performed than if the link rate is high, or than if the link rate is low and if the cache cost is low. Referring to FIGS. 8 and 9, if the cache cost is low in a state where the link rate is low, it may be verified that a cache allocation difference between UCA and GA-UCA is increased. However, if the cache cost is high in the state where the link rate is low, it may be verified that the cache allocation difference between the UCA and the GA-UCA is decreased.

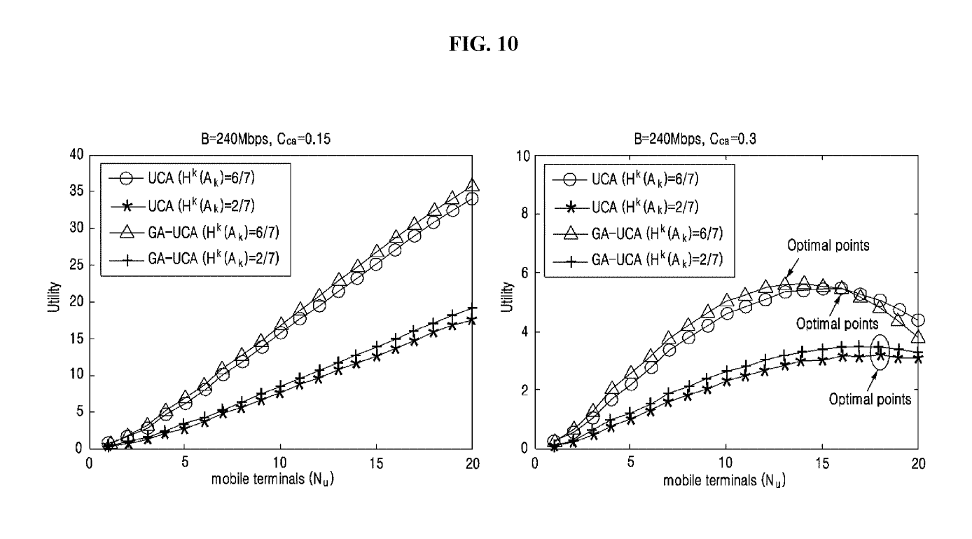

FIG. 10 is a drawing illustrating a utility based on a cache cost if a link rate is high in an embodiment.

A left graph in FIG. 10 may represent a utility if the link rate is high and if the cache cost is low, and a right graph in FIG. 10 may represent a utility if the link rate is high and if the cache cost is high. Herein, the utility may be calculated based on Equation 1 above.

According to FIG. 10, although the number of mobile terminals is greater than or equal to 20 if the cache cost is low, a cache may be increased and allocated. However, when the cache cost is high, if the number of mobile terminals is less than 20, there may be an optimal utility value. In other words, a WMN provider may determine the number of persons to be admitted for maximizing satisfaction of users who have mobile terminals. Thus, if the cache cost is high, it may be verified that users of more mobile terminals are met when a cache hit ratio is low.

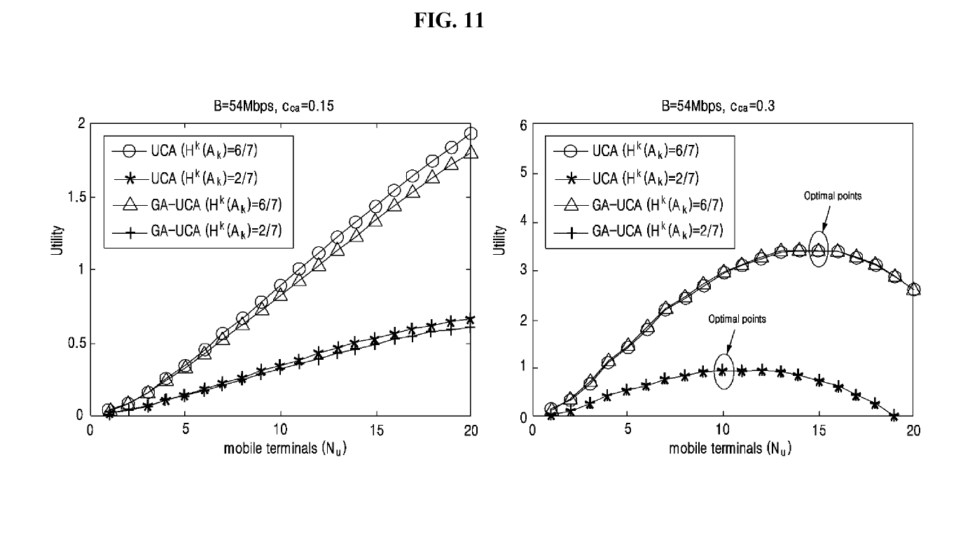

FIG. 11 is a drawing illustrating a utility based on a cache cost if a link rate is low in an embodiment.

A left graph in FIG. 11 may represent a utility if the link rate is low and if the cache cost is low, and a right graph in FIG. 11 may represent a utility if the link rate is low and if the cache cost is high.

According to FIG. 11, when the cache cost is low like the left graph, if a cache hit ratio is high, it may be verified that satisfaction of a user of a mobile terminal is higher in UCA than GA-UCA. In other words, it may be verified that a utility value of the UCA is higher than that of the GA-UCA. If the cache cost is low like FIG. 10, although the number of mobile terminals is greater than or equal to 20, an optimal cache may be increased and allocated.

If the cache cost is high like the right graph, it may be verified that an optimal utility value (e.g., optimal points) exists if the number of mobile terminal is less than 20. It may be verified that more users are met when a cache hit ratio is high (6/7) than when the cache hit ratio is low (2/7).

As described above with reference to FIGS. 10 and 11, the UCA may be performed to allocate more caches than the GA-UCA or the GA-UCA may be performed to allocate more caches than the UCA based on the link rate and the cache cost. Thus, in view of a WMN provider, a cache allocation device 200 of FIG. 2 may determine a suitable cache hit ratio as well as the number of persons to be admitted, such that a user of a mobile terminal has optimal satisfaction in consideration of a link rate and a cache cost of a WMN operated by the WMN provider. The cache allocation device 200 may enhance satisfaction of the user of the mobile terminal while maintaining the determined cache hit ratio. In view of the mobile terminal, the cache allocation device 200 may reduce a download delay of content by reducing an ETT value using the GA-UCA. Thus, the number of mobile terminals which download content such as a video on demand (VoD) over an infrastructure WMN may be increased. In other words, content may be downloaded in a shadow region of a space where buildings or persons are concentrated.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

According to embodiments, the UCA apparatus may reduce a download delay which occurs due to a decrease in throughput by a multi-hop in the infrastructure WMN environment by determining a cache allocation in consideration of a cache cost, a download delay of content, and user satisfaction.

Further, according to embodiments, the UCA apparatus may allocate more caches to mobile users by constructing a network at low cache costs by applying the 802.11 technology having an improved data rate to an MR in the infrastructure WMN environment.

Further, according to embodiments, the UCA apparatus may reduce a collision between mobile terminals by reducing a download delay when downloading popular content, as an MR uses a cache.

Therefore, other implements, other embodiments, and equivalents to claims are within the scope of the following claims.

What is claimed is:

1. A user centric cache allocation (UCA) method in an infrastructure wireless mesh network (WMN), the method comprising:
determining an allocation of a cache in a mesh router (MR) for content stored in the MR in an environment where mobile terminals and MRs establish the infrastructure WMN; and
allocating the cache for the content based on the determination allocation.

2. The method of claim 1, wherein the determining of the allocation of the cache comprises:
determining the allocation of the cache based on a cache cost generated as the MR operates a local cache, a download delay of content requested from the mobile terminal, and user satisfaction.

3. The method of claim 1, wherein the mobile terminal which requests the content accesses the closest MR from the mobile terminal among the MRs to receive the content.

4. The method of claim 3, further comprising:
searching for the requested content based on expected transmission time (ETT) routing, if there is no the requested content in the accessed MR.

5. The method of claim 1, wherein the MRs share content information stored in a cache of each of the MRs.

6. The method of claim 1, wherein the determining of the allocation of the cache comprises:
correcting an ETT value for searching for the content requested from a mobile terminal using a genetic algorithm (GA).

7. The method of claim 1, wherein the content stored in a storage of an MR is stored in a cache of the MR by moving to the cache of the MR, if the MR which stores the content requested from a mobile terminal corresponds to two hops or more from the mobile terminal.

8. The method of claim 1, wherein the content requested from the mobile terminal is stored in a storage of an MR adjacent to the mobile terminal by moving from a cache of an MR which stores the content to the storage of the MR adjacent to the mobile terminal.

9. The method of claim 1, wherein the determining of the allocation of the cache comprises:
determining the allocation of the cache for the content by repeatedly performing uniform crossover and mutation for the content requested from a mobile terminal, stored in at least one of the MRs.

10. A user centric cache allocation (UCA) apparatus in an infrastructure wireless mesh network (WMN), the apparatus comprising:
a determination unit configured to determine an allocation of a cache in a mesh router (MR) for content stored in the MR in an environment where mobile terminals and MRs establish the infrastructure WMN; and
an allocation unit configured to allocate the cache for the content based on the determination allocation.

11. The apparatus of claim 10, wherein the determination unit determines the allocation of the cache based on a cache cost generated as the MR operates a local cache, a download delay of content requested from the mobile terminal, and user satisfaction.

12. The apparatus of claim 10, wherein the mobile terminal which requests the content accesses the closest MR from the mobile terminal among the MRs to receive the content.

13. The apparatus of claim 12, further comprising:
a search unit configured to search for the requested content based on expected transmission time (ETT) routing, if there is no the requested content in the accessed MR.

14. The apparatus of claim 10, wherein the MRs share content information stored in a cache of each of the MRs.

15. The apparatus of claim 10, wherein the determination unit determines the allocation of the cache for the content in consideration of a cache hit ratio.

16. The apparatus of claim 10, wherein the determination unit corrects an ETT value for searching for the content requested from a mobile terminal using a genetic algorithm (GA).

17. The apparatus of claim 10, wherein the content stored in a storage of an MR is stored in a cache of the MR by moving to the cache of the MR, if the MR which stores the content requested from a mobile terminal corresponds to two hops or more from the mobile terminal.

18. The apparatus of claim 10, wherein the content requested from a mobile terminal is stored in a storage of an MR adjacent to the mobile terminal by moving from a cache of an MR which stores the content to the storage of the MR adjacent to the mobile terminal.

19. The apparatus of claim 10, wherein the determination unit determines the allocation of the cache for the content by repeatedly performing uniform crossover and mutation for the content requested from a mobile terminal, stored in at least one of the MRs.
